(19) United States
(12) Patent Application Publication
(10) Pub. No.: US 2006/0056847 A1
(43) Pub. Date: Mar. 16, 2006

(54) Optical control type microwave phase forming device

(76) Inventors: Tomohiro Akiyama, Tokyo (JP); Yoshihito Hirano, Tokyo (JP)

Correspondence Address: BIRCH STEWART KOLASCH & BIRCH, PO BOX 747, FALLS CHURCH, VA, 22040-0747, US

(21) Appl. No.: 10/537,100

(22) PCT Filed: Jul. 4, 2003
(86) PCT No.: PCT/JP03/08545

§ 371 Date: Jun. 2, 2005

(51) Int. Cl. H04B 10/24

(52) U.S. Cl. 398/41

(57) ABSTRACT

An optical control type microwave phase forming device includes: optical demultiplexers each for separating a light radiated from each of light sources into two branch lights; optical frequency converters each for deviating one of the two branch lights outputted from an optical demultiplexer by a predetermined frequency for outputting as a signal light; signal light emitting units each for converting the signal light into a signal light beam having a predetermined beam width to emit the signal light as a signal light beam to space; a spatial optical modulator for phase-modulating the signal light beams into signal light beams having a desired phase distribution; an optical multiplexer for converting the signal light beam outputted from the spatial optical modulator into a multiplex signal light beam to travel a coaxial optical path; an optical synthesizer for synthesizing the other branch lights outputted from the optical demultiplexers into a local light; a local light emitting unit for converting the local light into a light beam having a predetermined beam width to emit the light beam as a local light beam to space; and a beam synthesizer for spatially superimposing the signal light beam and the local light beam to form a synthesized beam.

### TECHNICAL FIELD

The present invention relates to an optical control type microwave phase forming device which can be applied to a multi-beam forming circuit for an array antenna for controlling, by using a light wave, a plurality of microwave beams radiated from an array antenna.

### BACKGROUND ART

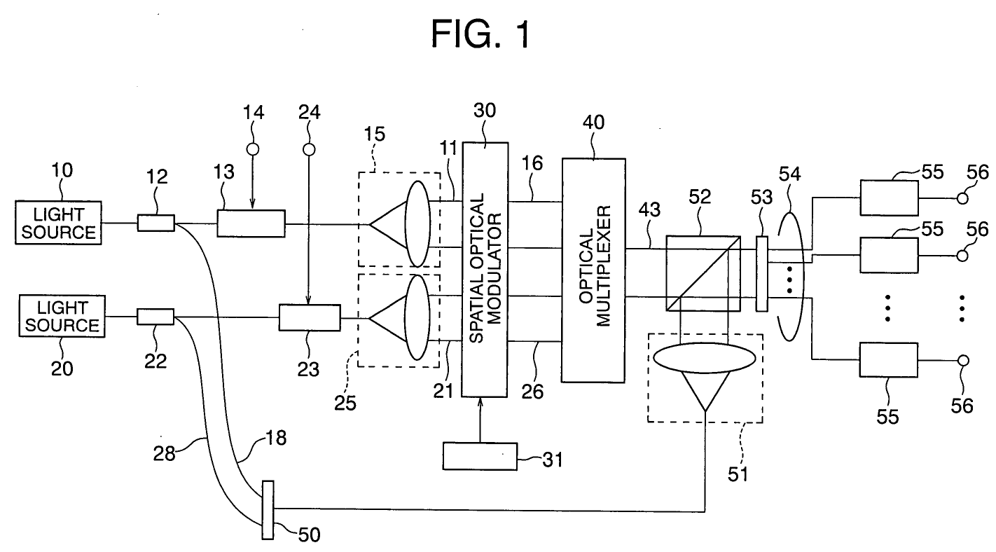

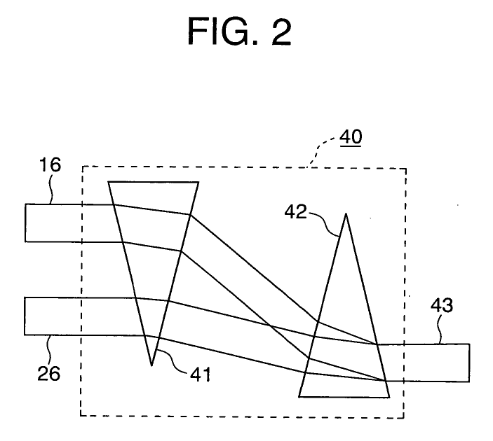

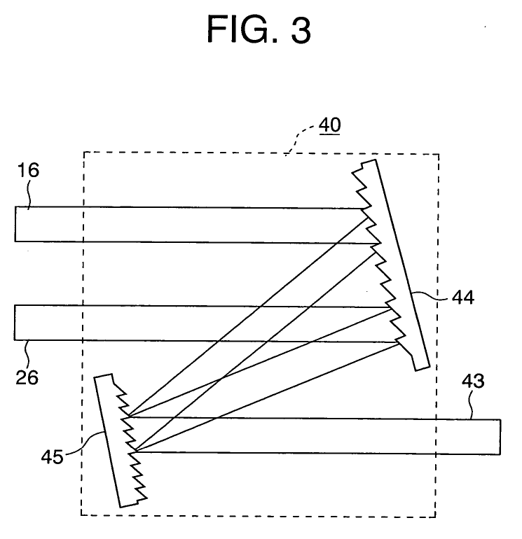

In a conventional optical control type microwave phase forming device, the device is radiated with first and second beam lights, frequencies of which are different from each other by a frequency of a microwave signal. The first beam light is converted as a signal light beam into a beam light having a feed amplitude/phase distribution for each of antenna elements of an array antenna by a spatial optical modulator, and the signal light beam and the second beam light as a local light beam are spatially superimposed with each other, and spatially sampled. The light obtained through the sampling is then converted into microwave signals through heterodyne detection by optoelectronic converters, respectively. Thereafter, the device is spatially radiated with the microwave signals through the array antenna (refer to JP 7-202547 A (FIGS. 1 and 2), and JP 6-276017 A (FIG. 3), for example).

In the conventional optical control type microwave phase controller described in JP 7-202547 A, an amplitude/phase signal formed in each of elements of a spatial optical modulator and a feed signal for each of elements of an array antenna show one-to-one correspondence. As a result, no more than one microwave phase wave surface can be formed by one spatial optical modulator, and hence there is a problem in that it is impossible to generate the feed signals for the array antenna for radiating a plurality of microwave beams.

In addition, FIG. 3 of JP6-276017A is concerned with multi-beam formation. However, in a construction shown in FIG. 3, directions of a plurality of beams are determined based on positions of masks, respectively. Therefore, a plurality of beams can not be directed in the same direction or can not be superimposed, and hence there is a problem in that the directions of a plurality of beams are limited among the mutual beams.

The present invention has been made in order to solve the above-mentioned problems, and it is, therefore, an object of the present invention to obtain an optical control type microwave phase forming device which is capable of simultaneously forming a plurality of microwave phase surfaces using one spatial optical modulator.

### DISCLOSURE OF THE INVENTION

An optical control type microwave phase forming device according to the present invention includes: a first optical demultiplexer for branching a light radiated from a first light source into two branch lights; a second optical demultiplexer for branching a light radiated from a second light source into two branch lights; a first optical frequency converter for deviating a frequency of one of the branch lights outputted from the first optical demultiplexer by a predetermined frequency based on a first microwave signal to output the resultant light as a first signal light; and a second optical frequency converter for deviating a frequency of one of the branch lights outputted from the second optical demultiplexer by a predetermined frequency based on a second microwave signal to output the resultant light as a second signal light.

In addition, the optical control type microwave phase forming device of the present invention further includes: a first signal light emitting unit for converting the first signal light into a signal light beam having a predetermined beam width to emit the signal light as a first signal light beam to space; a second signal light emitting unit for converting the second signal light into a signal light beam having a predetermined beam width to emit the signal light as a second signal light beam to space; a spatial optical modulator for phase-modulating the first and second signal light beams inputted to different areas thereof to convert the resultant signal light beams into signal light beams having respective desired spatial phase distributions; and an optical multiplexer for converting the first and second signal light beams different in wavelength outputted from the spatial optical modulator into a multiplex signal light beam to travel a coaxial optical path.

Furthermore, the optical control type microwave phase forming device according to the present invention further includes: an optical synthesizer for synthesizing the other branch light outputted from the first optical demultiplexer and the other branch light outputted from the second optical demultiplexer into a local light; a local light emitting unit for converting the local light into a light beam having a predetermined beam width to emit the light beam as a local light beam to space; a beam synthesizer for spatially superimposing the first and second light beams outputted from the optical multiplexer and the local light beam to form a synthetic beam; and a plurality of optoelectronic converters for spatially sampling the synthetic beam to convert the resultant beam into microwave signals through heterodyne detection to output the microwave signals, respectively.

### BRIEF DESCRIPTION OF THE DRWAINGS

FIG. 1 is a block diagram showing a construction of an optical control type microwave phase forming device according to Embodiment 1 of the present invention;

FIG. 2 is a diagram showing a construction of an optical multiplexer of the optical control type microwave phase forming device according to Embodiment 1 of the present invention;

FIG. 3 is a diagram showing a construction of an optical multiplexer of the optical control type microwave phase forming device according to Embodiment 2 of the present invention;

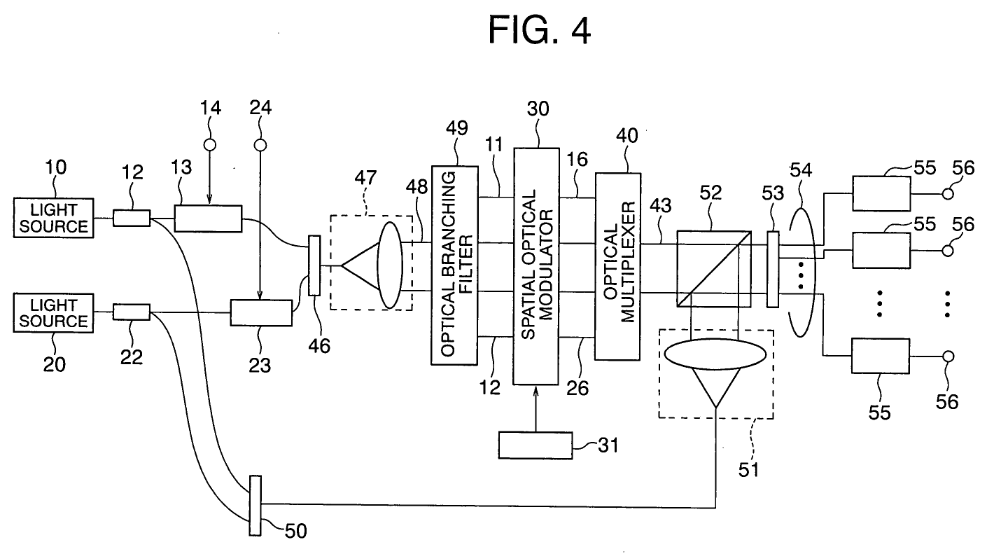

FIG. 4 is a block diagram showing a construction of an optical control type microwave phase forming device according to Embodiment 3 of the present invention;

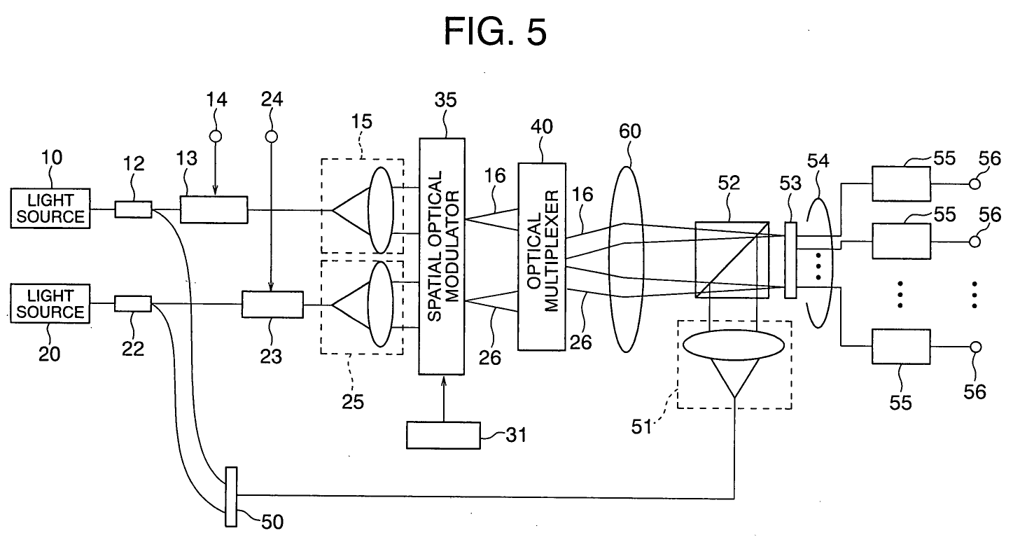

FIG. 5 is a block diagram showing a construction of an optical control type microwave phase forming device according to Embodiment 5 of the present invention;

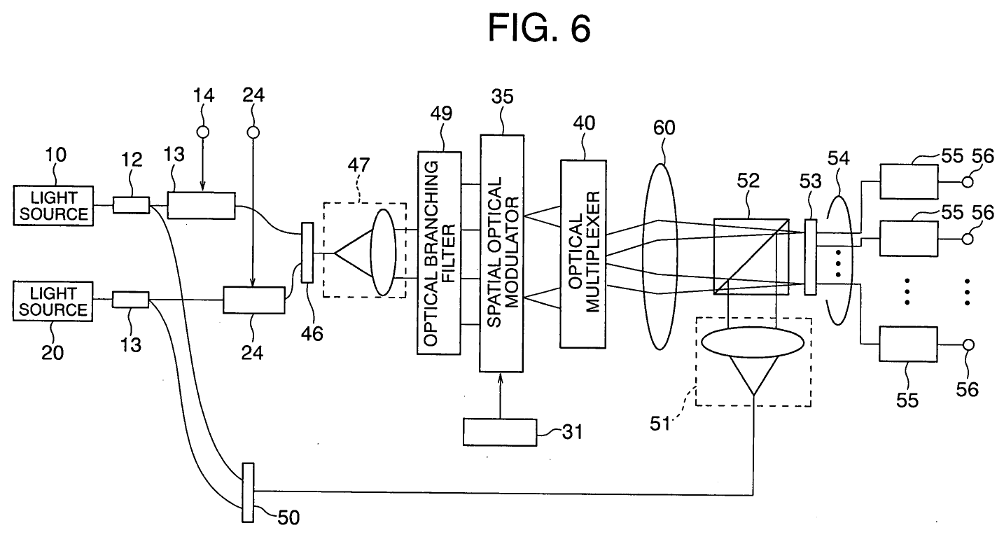

FIG. 6 is a block diagram showing a construction of an optical control type microwave phase forming device according to Embodiment 6 of the present invention; and

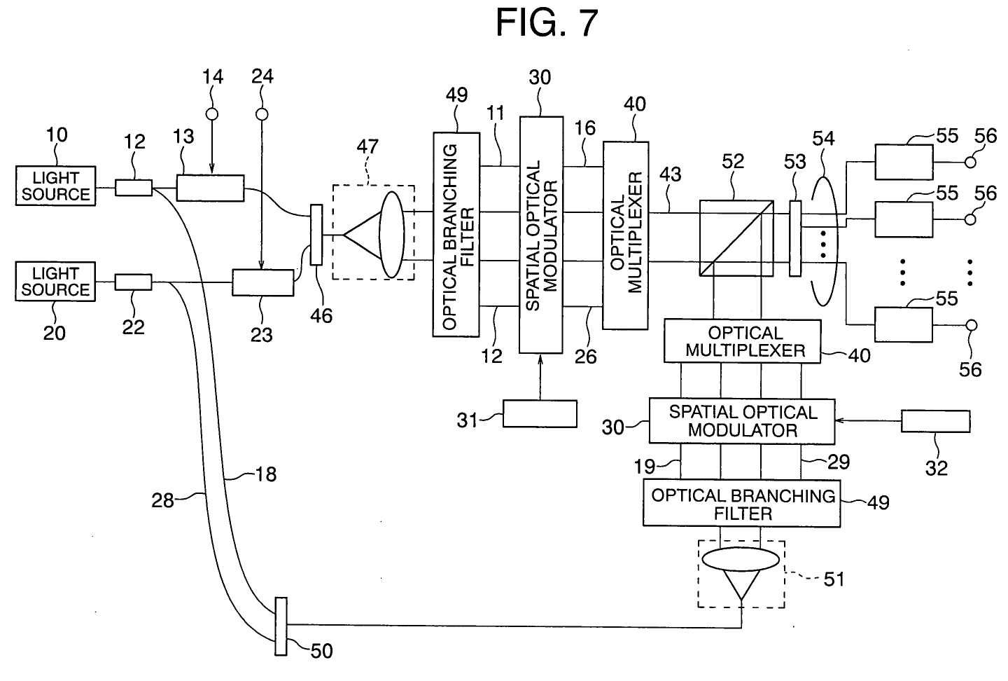

FIG. 7 is a block diagram showing a construction of an optical control type microwave phase forming device according to Embodiment 7 of the present invention.

### BEST MODE FOR CARRYING OUT THE INVENTION

Embodiments of the present invention will hereinafter be described based on the accompanying drawings.

### Embodiment 1

An optical control type microwave phase forming device according to Embodiment 1 of the present invention will now be described with reference to the corresponding drawings. FIG. 1 is a block diagram showing a construction of the optical control type microwave phase forming device according to Embodiment 1 of the present invention. Note that in the drawings, the same reference numerals designate the same or corresponding constituent elements.

In FIG. 1, the optical control type microwave phase forming device according to the present invention includes: light sources 10 and 20; optical demultiplexers 12 and 22; optical frequency converters 13 and 23; microwave signal input terminals 14 and 24; signal light emitting units 15 and 25; a spatial optical modulator 30; a spatial optical modulator controller 31; an optical multiplexer 40; an optical synthesizer 50; a local light emitting unit 51; a beam synthesizer 52; a lens array 53; an optical fiber array 54; optoelectronic converters 55; and microwave signal output terminals 56.

Next, an operation of the optical control type microwave phase forming device according to Embodiment 1 will be described with reference to the corresponding drawings. FIG. 2 is a diagram showing a construction of the optical multiplexer of the optical control type microwave phase forming device according to Embodiment 1.

As shown in FIG. 1, a light radiated from the light source 10 is branched into two branch lights by the optical demultiplexer 12. The optical frequency converter 13 deviates a frequency of one of the branch lights by a predetermined frequency using a first microwave signal inputted through the microwave signal input terminal 14 to output the resultant light as a signal light 11. The signal light 11 having the frequency obtained through the frequency deviation is converted into a signal light beam 11 having a predetermined beam width through the signal light emitting unit 15 constituted of an optical fiber and a lens for example, and the signal light beam 11 is then emitted to space. The signal light beam 11 emitted to space is then inputted to the spatial optical modulator 30. As for an optical frequency converter for deviating a frequency of a light, for example, an optical frequency shifter utilizing an acousto-optic effect is commercialized.

Likewise, a light radiated from the light source 20 for radiating a light having a wavelength different from that of the light radiated from the light source 10 is branched into two branch lights by the optical demultiplexer 22. The optical frequency converter 23 deviates the frequency of one of the branch lights by a predetermined frequency using a second microwave signal inputted through the microwave signal input terminal 24 to output the resultant light as a signal light 21. The signal light 21 having the frequency obtained through the frequency deviation is converted into a signal light beam 21 having a predetermined beam width through the signal light emitting unit 25 constituted of an optical fiber and a lens for example, and the signal light beam 21 is then inputted to an area on the spatial optical modulator 30 which is different from that for the signal light beam 11.

The signal light beam 11 and the signal light beam 21 which have been inputted to the different areas on the spatial optical modulator 30 are spatially modulated with their phases in accordance with an input signal sent from the spatial optical modulator controller 31 to be outputted in the form of signal light beams (output lights) 16 and 26 which are converted so as to have respective desired spatial phase distributions from the spatial optical modulator 30, respectively. Note that a liquid crystal element, for example, is given as the spatial optical modulator 30.

The signal light beams 16 and 26 outputted from the spatial optical modulator 30 are inputted to the optical multiplexer 40. The optical multiplexer 40 changes an optical path of an input signal light in correspondence to a wavelength, an incident position, and an incident angle of the input signal light. Thus, the optical multiplexer 40 converts the signal light beams 16 and 26 which are different in incident position and wavelength into a multiplex signal light beam to travel through a coaxial optical path to output the resultant multiplex signal light beam.

A function of the optical multiplexer 40 can be realized by utilizing the dependency of an angle of refraction or an angle of reflection on a wavelength in a wavelength dispersion element such as a prism or a diffraction grating. For example, as shown in FIG. 2, the optical multiplexer 40 can be constructed by combining two prisms 41 and 42 with each other. Incident light beams (the signal light beams 16 and 26) which are different in wavelength and have been inputted to the prism 41 are refracted at different angles in correspondence to their different wavelengths, respectively, to be emitted at different angles from the prism 41. The prism 42 is disposed in a place where the two emitted light beams intersect each other. The two emitted light beams are made incident to the prism 42. An intersection is uniquely determined by angles of refraction of the two incident light beams depending on the incidence conditions and the wavelengths of the two incident lights to the prism 41. Since the two lights which have been made incident at different angles to the prism 42 are refracted at different angles within the prism 42 in correspondence to their wavelengths, the two lights can be converted into a multiplex output light beam to travel through one and the same optical path.

A signal light beam (multiplex light) 43 which has been obtained through the multiplexing to be emitted from the optical multiplexer 40 so as to travel the coaxial optical path is inputted to the optical fiber array 54 through the beam synthesizer 52.

On the other hand, the other branch light 18 obtained by branching the light radiated from the light source 10 in the optical demultiplexer 12, and the other branch light 28 obtained by branching the light radiated from the light source 20 in the optical demultiplexer 22 are synthesized in the form of a local light by the optical synthesizer 50. The local light is then converted into a local light beam having a predetermined beam width through the local light emitting unit 51 constituted of an optical fiber, a lens, and the like. The local light beam is then spatially superimposed on the above-mentioned signal beam (multiplex light) 43 through the beam synthesizer 52 to obtain a synthetic beam which is in turn inputted to the optical fiber array 54.

An incidence-end side of the optical fiber array 54 may be provided with the lens array 53 in order to enhance a coupling efficiency of input lights to the respective optical fibers constituting the optical fiber array 54.

The lights which have been inputted to the respective optical fibers are propagated through the respective optical fibers to be inputted to the optoelectronic converters 55 connected to the optical fibers, respectively. The lights inputted to the respective optoelectronic converters 55 are then converted into microwave signals through the heterodyne detection to be outputted through the respective microwave signal output terminals 56. A phase distribution of each of the microwave signals becomes a phase distribution given by the spatial optical modulator 30.

In a case where the microwave signals are applied to an array antenna, the output signals outputted through the microwave signal output terminals 56 are fed to respective antenna elements of the array antenna through a microwave amplifier or the like as may be necessary to be radiated to space.

The microwave output signal outputted from a certain optoelectronic converter 55 will hereinafter be described. The frequency of the light source 10 is assigned fo1, the frequency of the microwave signal is assigned fm1, and a phase modulation amount of light in the element of the spatial optical modulator 30 becoming the incident light to the optical fiber to which attention is paid is assigned Φ1. Likewise, the frequency of the light source 20 is assigned fo2, the frequency of the microwave signal is assigned fm2, and a phase modulation amount of light is assigned Φ2.

The light inputted to the optoelectronic converter 55 contains the following four frequency components, assuming the amplitude of each of which to be 1:
cos(2π(fo1+fm1)t+Φ1);
cos(2πfo1t);
cos(2π(fo2+fm2)t+Φ2); and
cos(2πfo2t).
   A sum or difference between arbitrary two frequency components of those frequency components is outputted from the optoelectronic converter 55.

When a frequency difference in emitted light between the light source 10 and the light source 20 is wider than a frequency band of the optoelectronic converter 55, the frequency components of the microwave signal outputted from the optoelectronic converter 55 are the following two frequency components, and the phase modulation amounts Φ1 and Φ2 of light given by the spatial optical modulator 30 are superimposed on the frequency components of the microwave signal outputted from the optoelectronic converter 55, respectively:
cos(2πfm1t+Φ1); and
cos(2πfm2t+Φ2).

As in Embodiment 1, the lights which are modulated with the phases Φ1 and Φ2 in the different areas within the spatial optical modulator 30 can be converted by the optical multiplexer 40 into the multiplex signal beam to travel through one and the same optical path. Hence, the two lights and the microwave signals generated therefrom can be controlled independently of one another.

### Embodiment 2

An optical control type microwave phase forming device according to Embodiment 2 of the present invention will hereinafter be described with reference to the corresponding drawing. FIG. 3 is a diagram showing a construction of an optical multiplexer of the optical control type microwave phase forming device according to Embodiment 2 of the present invention.

In Embodiment 1 described above, the example of the optical multiplexer 40 constituted of the prisms 41 and 42 was shown. However, the function of the optical multiplexer 40 can also be realized by utilizing the dependency of an angle of reflection on a wavelength in a wavelength dispersion element such as a reflection type diffraction grating.

For example, the function of the optical multiplexer 40 can be realized by combining two diffraction gratings 44 and 45 with each other as shown in FIG. 3. Incident lights (the signal light beams 16 and 26) having different wavelengths and made incident to the diffraction grating 44 are reflected at different angles in correspondence to their wavelengths and incident angles. The diffraction grating 45 is disposed in a place where the two reflected lights intersect each other. Thus, the two reflected lights are made incident to the diffraction grating 45. An intersection is uniquely determined from an angle of refraction depending on the incidence conditions and the wavelengths of the two incident lights to the diffraction grating 44. The two lights which have been made incident at different angles to the diffraction grating 45 are reflected at different angles by the diffraction grating 45 in correspondence to their wavelengths. Hence, the reflected lights can be converted into the multiplex signal light beam to travel through one and the same optical path.

Such a function is not limited to a prism or a diffraction grating, and thus can be realized in the form of various constructions by utilizing the dependency of a refraction or reflection direction on a wavelength in an element having a wavelength dispersion property such as a photonic crystal.

### Embodiment 3

An optical control type microwave phase forming device according to Embodiment 3 of the present invention will hereinafter be described with reference to the corresponding drawing. FIG. 4 is a block diagram showing a construction of the optical control type microwave phase forming device according to Embodiment 3 of the present invention.

In FIG. 4, the optical control type microwave phase forming device according to the present invention includes: the light sources 10 and 20; the optical demultiplexers 12 and 22; the optical frequency converters 13 and 23; the microwave signal input terminals 14 and 24; an optical synthesizer 46; a signal light emitting unit 47; an optical branching filter 49; the spatial optical modulator 30; the spatial light modulator controller 31; the optical multiplexer 40; the optical synthesizer 50; the local light emitting unit 51; the beam synthesizer 52; the lens array 53; the optical fiber array 54; the optoelectronic converters 55; and the microwave signal output terminals 56.

Next, an operation of the optical control type microwave phase forming device according to Embodiment 3 will be described with reference to the corresponding drawing.

The signal lights 11 and 21 which have been changed in frequency after being radiated from the light source 10 and the light source 20 are synthesized by the optical synthesizer 46. A synthetic light 48 is then converted into a signal light beam having a predetermined beam width through the signal light emitting unit 47 to be inputted to the optical branching filter 49. The optical branching filter 49 outputs the input light from different places therein in correspondence to the wavelengths of the input light. The optical branching filter 49 is equal to an element which is obtained by changing input and output directions of the optical multiplexer 40. Thus, the signal light beams 11 and 21 are outputted from different places within the optical branching filter 49 in correspondence to their wavelength bands. The signal light beams 11 and 21 are inputted to different areas of the optical spatial modulator 30. An operation after the above operation is the same as that in Embodiment 1 described above.

The optical branching filter 49 can be realized, for example, based on a construction in which the light is inputted to the output side of the optical multiplexer 40 shown in FIG. 2 or 3, and is outputted from the input side thereof.

Application of the optical branching filter 49 to the input side of the spatial optical modulator 30 makes it possible to multiplex a plurality of lights between the optical synthesizer 46 and the lens (signal light emitting unit) 48. Thus, it is possible to reduce the number of transmission lines and the number of input lenses for the spatial optical modulator 30.

### Embodiment 4

An optical control type microwave phase forming device according to Embodiment 4 of the present invention will hereinafter be described.

In Embodiment 3 described above, the optical multiplexer 40 and the optical branching filter 49 are disposed symmetrically with respect to the spatial optical modulator 30. Thus, it is possible to eliminate the wavelength dependency on input and output directions and on places of the optical multiplexer 40 and the optical branching filter 49. Hence, even when the light sources having different wavelength bands are used, the optical multiplexer 40 and the optical branching filter 49 can cope with such a case without changing the disposition thereof.

In addition, also in a case where three or more light sources are used to form three or more microwave phase wave surfaces, the same construction in constituent elements in and after the optical synthesizer 46 as that of Embodiment 3 described above can be applied thereto.

### Embodiment 5

An optical control type microwave phase forming device according to Embodiment 5 of the present invention will hereinafter be described with reference to the corresponding drawing. FIG. 5 is a block diagram showing a construction of the optical control type microwave phase forming device according to Embodiment 5 of the present invention.

In FIG. 5, the optical control type microwave phase forming device according to the present invention includes: the light sources 10 and 20; the optical demultiplexers 12 and 22; the optical frequency converters 13 and 23; the microwave signal input terminals 14 and 24; the signal light emitting units 15 and 25; the spatial optical modulator controller 31; a spatial optical modulator 35; the optical multiplexer 40; a lens 60; the optical synthesizer 50; the local light emitting unit 51; the beam synthesizer 52; the lens array 53; the optical fiber array 54; the optoelectronic converters 55; and the microwave signal output terminals 56.

The lens 60 is disposed between the spatial optical modulator 35 and the optical fiber array 54. Also, the spatial optical modulator 35 is disposed so that its output surface agrees in position with a front-side focal surface of the lens 60, and the optical fiber array 54 or the lens array 53 is disposed so that its incidence end face agrees in position with a rear-side focal surface of the lens 60.

Next, an operation of the optical control type microwave phase forming device according to Embodiment 5 will be described with reference to the corresponding drawing.

The spatial optical modulator 35 converts intensity distributions of the signal lights 11 and 21 into intensity distributions of antenna radiation beams constituting a multi-beam, respectively. The lights 16 and 26 obtained through the intensity distribution are converted, similarly to Embodiments 1 and 2 described above, with their optical paths by the optical multiplexer 40, and then pass through the lens 60.

Here, the output surface of the spatial optical modulator 35 and the incidence end face of the optical fiber array 54 have a relationship of Fourier transform through the lens 60. Thus, the optical signals which are obtained by Fourier-transforming the output signals of the spatial optical modulator 35 are inputted to the optical fibers of the optical fiber array 54. Moreover, since the feed signal to the array antenna and the antenna radiation pattern in a long distance have also a relationship of Fourier transform, the intensity distributions of the output lights from the spatial optical modulator 35 and the antenna radiation pattern show a nearly analogous relationship. For example, when the spatial modulator 35 is given a triangular intensity distribution, the antenna radiation pattern becomes a triangle accordingly.

### Embodiment 6

An optical control type microwave phase forming device according to Embodiment 6 of the present invention will hereinafter be described with reference to the corresponding drawing. FIG. 6 is a block diagram showing a construction of the optical control type microwave phase forming device according to Embodiment 6 of the present invention.

In FIG. 6, the optical control type microwave phase forming device according to the present invention includes: the light sources 10 and 20; the optical demultiplexers 12 and 22; the optical frequency converters 13 and 23; the microwave signal input terminals 14 and 24; the optical synthesizer 46; the signal light emitting unit 47; the optical branching filter 49; the spatial optical modulator controller 31; the spatial optical modulator 35; the optical multiplexer 40; the lens 60; the optical synthesizer 50; the local light emitting unit 51; the beam synthesizer 52; the lens array 53; the optical fiber array 54; the optoelectronic converters 55; and the microwave signal output terminals 56.

Next, an operation of the optical control type microwave phase forming device according to Embodiment 6 will be described with reference to the corresponding drawing.

Similarly to Embodiment 3 described above, the lights which have been radiated from the light source 10 and the light source 20 are inputted to the different areas on the spatial optical modulator 35. The input signal lights 11 and 21 are intensity-modulated to be outputted by the spatial optical modulator 35 in correspondence to distributions corresponding to desired antenna radiation patterns, respectively, to operate similarly to the case of Embodiment 5 described above.

As a result, a plurality of lights can be multiplexed between the optical synthesizer 46 and the lens (signal light emitting unit) 47. Thus, it is possible to reduce the number of transmission lines, and the number of input lenses for the spatial optical modulator 35.

### Embodiment 7

An optical control type microwave phase forming device according to Embodiment 7 of the present invention will hereinafter be described with reference to the corresponding drawing. FIG. 7 is a block diagram showing a construction of the optical control type microwave phase forming device according to Embodiment 7 of the present invention.

In FIG. 7, the optical control type microwave phase forming device according to the present invention includes: the light sources 10 and 20; the optical demultiplexers 12 and 22; the optical frequency converters 13 and 23; the microwave signal input terminals 14 and 24; the optical synthesizer 46; the signal light emitting unit 47; the optical branching filters 49; the spatial optical modulators 30; the spatial optical modulator controllers 31 and 32; the optical multiplexers 40; the optical synthesizer 50; the local light emitting unit 51; the beam synthesizer 52; the lens array 53; the optical fiber array 54; the optoelectronic converters 55; and the microwave signal output terminals 56.

Next, an operation of the optical control type microwave phase forming device according to Embodiment 7 will be described with reference to the corresponding drawing.

The branch lights 18 and 28 which have been radiated from the light sources 10 and 20, respectively, are synthesized by the optical synthesizer 50, and a synthetic light is then radiated with a predetermined beam width to space from the lens (local light emitting unit) 51. By the optical branching filter 49, the radiated light is branched into lights 19 and 29 having respective optical paths which are different from each other in correspondence to their wavelengths. The output lights 19 and 29 are then inputted to the input side of the spatial optical modulator 30.

The spatial intensity distributions of the output lights 19 and 29 are converted into predetermined intensity distributions, respectively, and after the intensity distribution conversion, the resultant lights are outputted from the spatial optical modulator 30. The output lights are converted into a multiplex signal light to travel through one and the same optical path by the optical multiplexer 40. The multiplex signal light is then inputted to the optical fiber array 54 through the beam synthesizer 52.

In addition to the phase distribution, the intensity distribution can also be controlled, which results in enhancement of the reduction of the side lobe of the radiated beams from the array antennas, and the flexibility in the control or the like over the beam widths.

### Embodiment 8

While in Embodiment 7 described above, the intensity modulation is carried out for the branch lights 18 and 28, the spatial optical modulator 35 may be inserted in the spatial optical modulator 30 on an incidence side or an emission side thereof in order to carry out the intensity modulation of the branch lights 18 and 28.

### Embodiment 9

While in each of Embodiments described above, two multi-beams are generated using the two light sources, it is to be understood that a circuit for forming three or more multi-beams can be realized using three or more light sources.

### Embodiment 10

While each of Embodiments described above has been explained with respect to the construction using the transmission type spatial optical modulator 30, it is to be understood that a reflection type spatial optical modulator can also be applied.

### Embodiment 11

While in each of Embodiments described above, the branch light 11 from the light source 10 is frequency-converted, the frequency of the other branch light 18 may be deviated. In addition, both of the frequencies of the branch light 11 and the branch light 18 may be converted.

### Embodiment 12

While in each of Embodiments described above, one light source and the frequency converter are used to form one microwave, two light sources may also be used and the wavelengths of the light from the two light sources may be controlled such that a frequency difference in light between the two light sources becomes a desired microwave frequency.

### Embodiment 13

While in each of Embodiments described above, after completion of the sampling of the light, the lights are transmitted to the optoelectronic converters 55 through the optical fiber array 54, respectively, the lights may be directly applied to an array of the optoelectronic converters 55 without through the optical fiber array 54.

### INDUSTRIAL APPLICABILITY

The optical control type microwave phase forming device according to the present invention, as described above, can be applied to the multi-beam forming circuit for an array antenna. Thus, by using the optical multiplexer for multiplexing a plurality of lights different in wavelength band and a plurality of lights traveling through respective optical paths, lights outputted from different areas on one spatial optical modulator can be converted into a multiplex light signal to travel through one and the same optical path. Hence, a plurality of microwave phase surfaces can be simultaneously formed by one spatial optical modulator.

1. An optical control type microwave phase forming device, comprising:
a first optical demultiplexer for branching a light radiated from a first light source into two branch lights;
a second optical demultiplexer for branching a light radiated from a second light source into two branch lights;
a first optical frequency converter for deviating a frequency of one of the branch lights outputted from the first optical demultiplexer by a predetermined frequency based on a first microwave signal to output the resultant light as a first signal light;
a second optical frequency converter for deviating a frequency of one of the branch lights outputted from the second optical demultiplexer by a predetermined frequency based on a second microwave signal to output the resultant light as a second signal light;
a first signal light emitting unit for converting the first signal light into a signal light beam having a predetermined beam width to emit the signal light as a first signal light beam to space;
a second signal light emitting unit for converting the second signal light into a signal light beam having a predetermined beam width to emit the signal light as a second signal light beam to space;
a spatial optical modulator for phase-modulating the first and second signal light beams inputted to different areas thereof to convert the resultant signal light beams into signal light beams having respective desired spatial phase distributions;
an optical multiplexer for converting the first and second signal light beams different in wavelength outputted from the spatial optical modulator into a multiplex signal light beam to travel a coaxial optical path;
an optical synthesizer for synthesizing the other branch light outputted from the first optical demultiplexer and the other branch light outputted from the second optical demultiplexer into a local light;
a local light emitting unit for converting the local light into a light beam having a predetermined beam width to emit the light beam as a local light beam to space;
a beam synthesizer for spatially superimposing the first and second light beams outputted from the optical multiplexer, and the local light beam to form a synthetic beam; and
a plurality of optoelectronic converters for spatially sampling the synthetic beam to convert the resultant beam into microwave signals through heterodyne detection to output the microwave signals, respectively.

2. An optical control type microwave phase forming device according to claim 1, wherein the spatial optical modulator intensity-modulates the first and second signal light beams to convert the resultant signal light beams into signal light beams having respective desired spatial intensity distributions instead of phase-modulating the first and second signal light beams to convert the resultant signal light beams into signal light beams having respective desired spatial phase distributions,
the optical control type microwave phase forming device further comprising:
an optical fiber array for transmitting the synthetic beam outputted from the beam synthesizer to the plurality of optoelectronic converters; and
a lens for Fourier-transforming the first and second signal light beams outputted from the spatial optical modulator, the lens being disposed so that its front-side focal surface agrees in position with an output surface of the spatial optical modulator, and its rear-side focal surface agrees in position with an incidence end face of the optical fiber array.

3. An optical control type microwave phase forming device, comprising:
a first optical demultiplexer for branching a light radiated from a first light source into two branch lights;
a second optical demultiplexer for branching a light radiated from a second light source into two branch lights;
a first optical frequency converter for deviating a frequency of one of the branch lights outputted from the first optical demultiplexer by a predetermined frequency based on a first microwave signal to output the resultant light as a first signal light;
a second optical frequency converter for deviating a frequency of one of the branch lights outputted from the second optical demultiplexer by a predetermined frequency based on a second microwave signal to output the resultant light as a second signal light;
a first optical synthesizer for synthesizing the first and second signal lights;
a signal light emitting unit for converting the synthetic light outputted from the first optical synthesizer into a signal light beam having a predetermined beam width to emit the signal light as a synthetic signal light beam to space;
an optical branching filter for spatially separating the synthetic signal beam in correspondence to a wavelength band of the synthetic signal light to output first and second signal light beams obtained through the spatial separation;
a spatial optical modulator for phase-modulating the first and second signal light beams inputted to different areas thereof to convert the resultant signal light beams into signal light beams having respective desired spatial phase distributions;
an optical multiplexer for converting the first and second signal light beams different in wavelength outputted from the spatial optical modulator into a multiplex signal light beam to travel a coaxial optical path;
a second optical synthesizer for synthesizing the other branch light outputted from the first optical demultiplexer and the other branch light outputted from the second optical demultiplexer into a local light;
a local light emitting unit for converting the local light into a light beam having a predetermined beam width to emit the light beam as a local light beam to space;
a beam synthesizer for spatially superimposing the first and second light beams outputted from the optical multiplexer and the local light beam to form a synthetic beam; and
a plurality of optoelectronic converters for spatially sampling the synthetic beam to convert the resultant beam into microwave signals through heterodyne detection to output the microwave signals, respectively.

4. An optical control type microwave phase forming device according to claim 3, wherein the optical branching filter and the optical multiplexer are disposed symmetrically with respect to the spatial optical modulator.

5. An optical control type microwave phase forming device according to claim 3, wherein the spatial optical modulator intensity-modulates the first and second signal light beams to convert the resultant signal light beams into signal light beams having respective desired spatial intensity distributions instead of phase-modulating the first and second signal light beams to convert the resultant signal light beams into signal light beams having respective desired spatial phase distributions,
the optical control type microwave phase forming device further comprising:
an optical fiber array for transmitting the synthetic beam outputted from the beam synthesizer to the plurality of optoelectronic converters; and
a lens for Fourier-transforming the first and second signal light beams outputted from the spatial optical modulator, the lens being disposed so that its front-side focal surface agrees in position with an output surface of the spatial optical modulator, and its rear-side focal surface agrees in position with an incidence end face of the optical fiber array.

6. An optical control type microwave phase forming device according to claim 3, further comprising:
a second optical branching filter for spatially separating the local light beam in correspondence to a wavelength band of the local light beam to output first and second local light beams obtained through the spatial separation;
a second spatial modulator for phase-modulating the first and second local light beams inputted to different areas thereof to convert the resultant light beams into light beams having respective desired spatial phase distributions; and
a second optical multiplexer for converting first and second local light beams different in wavelength outputted from the spatial optical modulator into a multiplex light beam to travel through a coaxial optical path,
wherein the beam synthesizer spatially superimposes the first and second signal light beams outputted from the optical multiplexer, and the first and second local light beams outputted from the second optical multiplexer to form a synthetic beam, instead of spatially superimposing the first and second signal light beams outputted from the optical multiplexer and the local light beam.
